(19) United States
(12) Patent Application Publication
(10) Pub. No.: US 2024/0248436 A1
(43) Pub. Date: Jul. 25, 2024

(54) OPTIMIZING COLLABORATIVE WORK AMONG ROBOTIC MACHINES

(71) Applicant: INTERNATIONAL BUSINESS MACHINES CORPORATION, ARMONK, NY (US)

(72) Inventors: Jennifer M. Hatfield, San Francisco, CA (US); Jeremy R. Fox, Georgetown, TX (US); Tushar Agrawal, West Fargo, ND (US); Sarbajit K. Rakshit, Kolkata (IN)

(21) Appl. No.: 18/158,535

(22) Filed: Jan. 24, 2023

(51) Int. Cl. G05B 13/02; B25J 9/16

(52) U.S. Cl. CPC G05B 13/0265; B25J 9/1605; B25J 9/163; B25J 9/1682; G05B 2219/31053

(57) ABSTRACT

Described are techniques for optimizing collaborative work performed by robotic machines in an industrial environment. The techniques include obtaining industrial activity data comprising steps of industrial activities performed by robotic machines on an industrial floor. The techniques further include obtaining robotic machine data comprising configuration information of the robotic machines associated with performing the steps of the industrial activities. The techniques further include inputting the industrial activity data and the robotic machine data to a machine learning model to analyze the steps of the industrial activities in view of the configuration information of the robotic machines to generate a production plan that aggregates performance of selected steps by the robotic machines, and configuring the robotic machines on the industrial floor according to the production plan generated by the machine learning model.

### BACKGROUND

The present disclosure relates to industrial automation, and, more specifically, to optimizing collaborative work performed by robotic machines in an industrial environment.

In an industrial environment, industrial robotics can be utilized in various manufacturing processes. Such manufacturing processes can include: machining, welding, painting, assembling, and material handling to name just a few. Industrial robotics use various mechanical, electrical, as well as software systems to allow for high precision, accuracy, and speed to exceed comparable human performance. Intelligent workflows can be used to integrate data obtained from robotic machines (e.g., via sensors, cameras, microphones, processors, software, etc.) that perform manufacturing processes, and the data can be provided to back-end support systems that monitor and evaluate the manufacturing processes.

### SUMMARY

Aspects of the present disclosure are directed toward a computer-implemented method comprising obtaining industrial activity data comprising steps of industrial activities performed by robotic machines on an industrial floor. The computer-implemented method further comprising obtaining robotic machine data comprising configuration information of the robotic machines associated with performing the steps of the industrial activities. The computer-implemented method further comprising inputting the industrial activity data and the robotic machine data to a machine learning model to analyze the steps of the industrial activities in view of the configuration information of the robotic machines to generate a production plan that aggregates performance of selected steps by the robotic machines. The computer-implemented method further comprising configuring the robotic machines on the industrial floor according to the production plan generated by the machine learning model.

Additional aspects of the present disclosure are directed to systems and computer program products configured to perform the methods described above. The present summary is not intended to illustrate each aspect of, every implementation of, and/or every embodiment of the present disclosure.

### BRIEF DESCRIPTION OF THE DRAWINGS

The drawings included in the present application are incorporated into and form part of the specification. They illustrate embodiments of the present disclosure and, along with the description, serve to explain the principles of the disclosure. The drawings are only illustrative of certain embodiments and do not limit the disclosure.

FIG. 1 is a block diagram illustrating an example environment implementing collaborative work optimization among robotic machines in an industrial environment, in accordance with some embodiments of the present disclosure.

FIG. 2 is a flow diagram that illustrates an example method for building an activity knowledge corpus, in accordance with some embodiments of the present disclosure.

FIG. 3 is a flow diagram illustrating an example method for creating a production plan that optimizes one or more industrial activities, in accordance with some embodiments of the present disclosure.

FIG. 4 is a flow diagram illustrating an example method for configuring robotic machines on an industrial floor according to a production plan generated by a machine learning model, in accordance with some embodiments of the present disclosure.

FIG. 5 is a block diagram that illustrates an example computing environment in which aspects of the present disclosure can be implemented, in accordance with some embodiments of the present disclosure.

While the present disclosure is amenable to various modifications and alternative forms, specifics thereof have been shown by way of example in the drawings and will be described in detail. It should be understood, however, that the intention is not to limit the present disclosure to the particular embodiments described. On the contrary, the intention is to cover all modifications, equivalents, and alternatives falling within the spirit and scope of the present disclosure.

### DETAILED DESCRIPTION

Aspects of the present disclosure are directed toward optimizing collaborative work performed by robotic machines in an industrial environment. While not limited to such applications, embodiments of the present disclosure may be better understood in light of the aforementioned context.

Industrial automation utilizes control systems and robotic machines (also referred to as industrial robots and robotic devices) to perform different activities to complete a task. A robotic machine can include, but is not limited to, an automated machine configured to execute specific tasks with speed and precision with no human, or limited human, intervention. As an example, a robotic machine can comprise a robot system used for manufacturing that is automated, programmable, and capable of movement on three or more axes. Example industrial automation systems use robotic machines for preforming industrial activities, including, but not limited to: machining, assembly, disassembly, welding, painting, pick and place for printed circuit boards, packaging and labeling, palletizing, product inspection, and testing, which can be accomplished with high endurance, speed, and precision.

On an industrial floor, the same activity can be performed, or command can be executed, by various robotic machines operating as part of an industrial automation system. While performing an industrial activity, the robotic machines are performing one or more combinations of value-added and nonvalue-added steps. While some nonvalue-added steps may be essential, other nonvalue-added steps (e.g., waiting times, material movement, duplicate steps, etc.) are not essential and can result in lost productivity, increased energy use, increased machine breakage and repair, as well as other inefficiencies.

Advantageously, aspects of the present disclosure overcome these challenges by optimizing a production plan for an industrial floor. More specifically, aspects of the present disclosure use machine learning to assign the steps of an industrial activity to one or more robotic machines so as to reduce nonvalue-added steps of the industrial activity and increase efficiency of performing the industrial activity.

Illustratively, industrial activity data comprising the steps of industrial activities performed by the robotic machines and robotic machine data comprising configuration information of the robotic machines associated with performing the steps of the industrial activities can be input to the machine learning model. The machine learning model evaluates the steps of the industrial activities in view of the configuration information of the robotic machines to generate a production plan that aggregates performance of selected steps by the robotic machines, and reduces the performance of nonvalue-added steps by the robotic machines. Aspects of the present disclosure can then configure the robotic machines on the industrial floor according to the production plan generated by the machine learning model.

Aspects of the present disclosure that create a production plan using machine learning improve the performance of an industrial automation system. More specifically, by determining step assignments that aggregate step performance and reduces performance of nonvalue-added steps, robotic machines on an industrial floor can be configured to perform industrial activities more efficiently and more effectively. Thus, configuring the robotic machines according to the production plan created using machine learning is an improvement to a computer-related technology in the area of industrial automation systems.

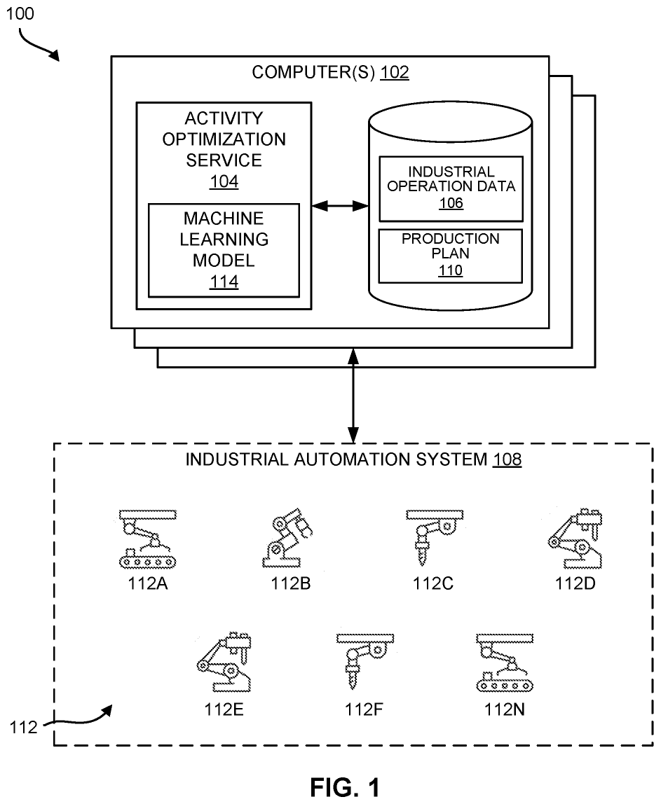

Referring now to the figures, FIG. 1 illustrates a block diagram of an example environment 100 that can implement collaborative work optimization among robotic machines 112 included as part of an industrial automation system 108, in accordance with some embodiments of the present disclosure. As illustrated, the example environment 100 can include one or more computers 102 that host an activity optimization service 104, and an industrial automation system 108 that includes a plurality of robotic machines 112, (i.e., robotic machines 112A, 112B, 112C, 112D, 112E, 112F, up to, and including, 112N, where N can refer to any positive integer representing any number of robotic machines).

The industrial automation system 108 comprises control systems, including robotic machines 112, actuators, sensors, processors, and networks configured to perform steps or tasks that automate various industrial activities. The industrial activities (also referred to herein as activities) can include, but are not limited to, manufacturing, production, assembling, altering, formulating, repairing, renovating, ornamenting, finishing, cleaning, washing, dismantling, transforming, processing, recycling, adapting, or servicing of goods, products, articles, substances, or food, and can include any storage or transportation associated with any such activity. The robotic machines 112 included in the industrial automation system 108 can comprise any robot system, including articulated robots, cartesian coordinate robots, cylindrical coordinate robots, spherical coordinate robots, selective compliance assembly robot arms, parallel link robots, serial manipulators, and the like. The robotic machines 112 can be configured (via commands and physical placements on an industrial floor) to work together to accomplish one or more industrial activities. A production plan 110 for the industrial automation system 108 provides details for a physical layout of the robotic machines 112 on the industrial floor, and assigns each robotic machine 112 one or more steps of an industrial activity to perform.

The activity optimization service 104 creates a production plan 110 for the industrial automation system 108 that endeavors to optimize collaboration among the robotic machines 112 to perform one or more industrial activities. The activity optimization service 104 creates a production plan 110 by analyzing industrial operation data 106 associated with the industrial automation system 108 to identify opportunities to aggregate or combine steps of the one or more industrial activities performed by the robotic machines 112. The activity optimization service 104 then determines whether aggregating the steps improves the overall ability of the industrial automation system 108 to perform the one or more industrial activities (e.g., improves production time, production quality, robotic machine utilization, etc.). In the case that aggregating the steps is expected to improve industrial activity performance, the activity optimization service 104 creates a production plan 110 for the industrial automation system 108, which includes specifications for a physical layout of the robotic machines 112 on the industrial floor, and/or assigns each robotic machine 112 one or more steps of the one or more industrial activities to perform.

Industrial operation data 106 associated with the industrial automation system 108 can include various information, including: industrial activity data, robotic machine data, industrial floor layout information, as well as other information for the industrial automation system 108, as will be appreciated. Industrial activity data comprises historical and/or current information for one or more activities performed by the industrial automation system 108. In some embodiments, the industrial activity data provides details about steps of an industrial activity that are assigned to one or more robotic machines 112. As a non-limiting example, where an industrial activity includes several steps, the industrial activity data can indicate that robotic machine 112A performs steps one and two, robotic machine 112B performs step three, and robotic machine 112C performs step four, and so forth. Robotic machine data comprises configuration information for the robotic machines 112. The robotic machine data can indicate physical and software specifications of the robotic machines 112 associated with an ability to perform aspects of an activity. Industrial floor information comprises specifications for the industrial floor, including industrial floor dimensions, a current layout of robotic machines 112 on the industrial floor, and historical layouts of robotic machines 112 on the industrial floor.

The activity optimization service 104, in some embodiments, analyzes industrial operation data 106 using machine learning to identify opportunities to aggregate performance of selected steps of one or more industrial activities. For example, a machine learning model 114 can be trained to analyze industrial operation data 106 for the industrial automation system 108 and identify steps among one or more industrial activities to aggregate. The machine learning model 114 analyzes the steps in view of configuration information for the robotic machines 112 to determine whether the abilities and/or physical placement of the robotic machines 112 allows any of the steps to be aggregated, and whether aggregating the steps results in improved performance of the one or more industrial activities. In some embodiments, the machine learning model 114 also analyzes the steps and configuration information of the robotic machines 112 in view of industrial floor information to determine optimal physical placement of the robotic machines 112 on the industrial floor. In the case that the machine learning model 114 determines that aggregating the steps results in improved performance of the one or more industrial activities, the activity optimization service 104 creates a production plan 110 from the output of the machine learning model 114 (e.g., robotic machine placements and step assignments).

In some embodiments, the activity optimization service 104 classifies the steps of an industrial activity as value-added or nonvalue added steps. Value-added steps are those steps that are necessary for outputting an object (e.g., a product) of an industrial activity. For example, actions that are directly applied to an object of an industrial activity in order to create, assemble, form, and/or transform the object, may be value-added steps. Nonvalue-added steps are actions that may not directly contribute to the creation, assembly, forming, and/or transforming of the object of the industrial activity. For example, actions that transport, position, transfer, clean, etc. may be nonvalue-added steps of the industrial activity. As will be appreciated, what are considered value-added and nonvalue-added steps of a particular industrial activity may depend upon the context of the industrial activity and the contribution of the steps to an object output by the industrial activity. In some examples, the activity optimization service 104 performs step classification using machine learning. After classifying the steps of an industry activity as value-added or nonvalue-added, the activity optimization service 104 analyzes the industrial operation data 106, in view of the step classifications, to identify opportunities to aggregate performance of nonvalue-added steps that results in reducing the number of nonvalue-added steps performed by the robotic machines 112. As an illustration, nonvalue added steps that move parts of a product one part at a time may be aggregated or combined to one or more steps that move multiple parts of the product at one time.

As part of creating a production plan 110, the activity optimization service 104 can identify a derived sequence of steps for aggregated robotic machine collaboration. The activity optimization service 104 identifies a sequence of steps for one or more industrial activities while assigning the steps to different robotic machines 112. In some examples, the activity optimization service 104 identifies sequences of steps for aggregated robotic machine collaboration using machine learning. A sequence of steps can be identified in a such a way that aggregated nonvalue-added steps can be reduced. As an example, after performing a first step of an industrial activity, robotic machine 112A may need to be cleaned before performing a second step of the industrial activity. As part of identifying this sequence, the activity optimization service 104 identifies robotic machine 112N that is able to perform the second step, and rather than waiting for robotic machine 112A to be cleaned, assigns robotic machine 112N to perform the second step.

In some embodiments, the activity optimization service 104 performs physical distance collaboration analysis for the robotic machines 112 to identify sets or groups of robotic machines 112 to collaborate on one or more steps of one or more industrial activities (e.g., industrial activities having common steps). The activity optimization service 104 identifies a physical distance among the robotic machines 112, production capacity of the robotic machines 112 (e.g., maximum amount of work a robotic machine 112 is capable of), and/or health conditions of the robotic machines 112 (e.g., mechanical condition, software version, robot model version, battery condition, etc.), and the activity optimization service 104 analyzes this information in view of other industrial operation data 106 (e.g., industrial activity data and industrial floor layout information) to identify sets or groups of robotic machines 112 that can work together to aggregate performance of steps of the one or more industrial activities, thereby reducing the number of steps that would have otherwise to be performed by the industrial automation system 108. In some examples, the activity optimization service 104 performs the physical distance collaboration analysis using machine learning.

In some embodiments, the activity optimization service 104 identifies and reduces wasted nonvalue-added steps based on historical analysis of industrial activities. For example, the activity optimization service 104 can analyze historical industrial operation data (which can be included in industrial operation data 106) to identify which steps are nonvalue-added steps, and identify one or more robotic machines 112 that can be used to eliminate or reduce the nonvalue-added steps. The activity optimization service 104 can then provide a recommendation for the one or more robotic machines 112 to be installed on the industrial floor.

In some embodiments, based on the analysis of historical industrial operation data, the activity optimization service 104 can generate predictions for new industrial activities. For example, proposed changes to a current industrial activity/current production plan (e.g., add/remove robotic machine 112, new industrial floor configuration, etc.) can be input to the activity optimization service 104, and the activity optimization service 104 can analyze the changes in view of the current production plan and recommend a new production plan that is expected to optimize collaborative work among robotic machines 112. In some embodiments, the activity optimization service 104 can track the steps of one or more industrial activities and adjust performance of the steps over time as new industrial activities are added and current industrial activities and steps are optimized. Optimization can be accelerated through predictive analysis of potential new activities, their steps, and value measured prior to activation of a new industrial activity. In some embodiments, the activity optimization service 104 can predict new robotic machine dynamic location inclusion. As one or more new robotic machines are nearing delivery, completion, or introduction into an industrial automation system 108, the activity optimization service 104 can provide a reconfiguration of a production plan 110 in preparation for the arrival of the one or more new robotic machines, thereby allowing for a smoother transition pertaining to the ability to rework industrial activities for the anticipated new robotic machines.

The activity optimization service 104 can be implemented in software, hardware, firmware, or a combination thereof. When implemented in hardware, the hardware can include circuits that operate to perform the operations of the activity optimization service 104. When implemented in software, the operations performed by the activity optimization service 104 can be implemented in program instructions configured to run on hardware, such as a processor unit. When firmware is used, the operations performed by the activity optimization service 104 can be implemented in program instructions and data and stored in persistent memory to run on a processor unit.

The one or more computers 102 can be physical hardware systems that include one or more data processing systems. When more than one data processing system is present in a computer 102, the data processing systems are in communication with each other using a communications medium. The communications medium can be a network. The data processing systems can be selected from at least one of a computer, a server computer, or some other suitable data processing system. The hardware can take a form selected from at least one of a circuit system, an integrated circuit, an application specific integrated circuit (ASIC), a programmable logic device, or some other suitable type of hardware configured to perform a number of operations. With a programmable logic device, the device can be configured to perform the number of operations. The device can be reconfigured at a later time or can be permanently configured to perform the number of operations. Programmable logic devices include, for example, a programmable logic array, a programmable array logic, a field programmable logic array, a field programmable gate array, and other suitable hardware devices. Additionally, the processes can be implemented in organic components integrated with inorganic components and can be comprised entirely of organic components excluding a human being. For example, the processes can be implemented as circuits in organic semiconductors.

In some embodiments, the activity optimization service 104 can be implemented as one or more computing services hosted in a computing service environment. For example, the activity optimization service 104 can be considered a service with one or more processes executing on a server or other computer hardware. The service can provide a service application that receives requests and provides output to other services or consumer devices. An API can be provided for each module of the service to enable a first module to send requests to and receive output from a second module. Such APIs can also allow third parties to interface with the service and make requests and receive output from the service.

A network (not shown) can be provided to enable communication between the components in the example environment 100. The network can include any useful computing network, including an intranet, the Internet, a local area network, a wide area network, a wireless data network, or any other such network or combination thereof. Components utilized for the network can depend at least in part upon the type of network and/or environment selected. Communication over the network can be enabled by wired or wireless connections and combinations thereof. While FIG. 1 illustrates an example environment that can implement the techniques above, many other similar or different environments are possible. The example environments discussed and illustrated above are merely representative and not limiting.

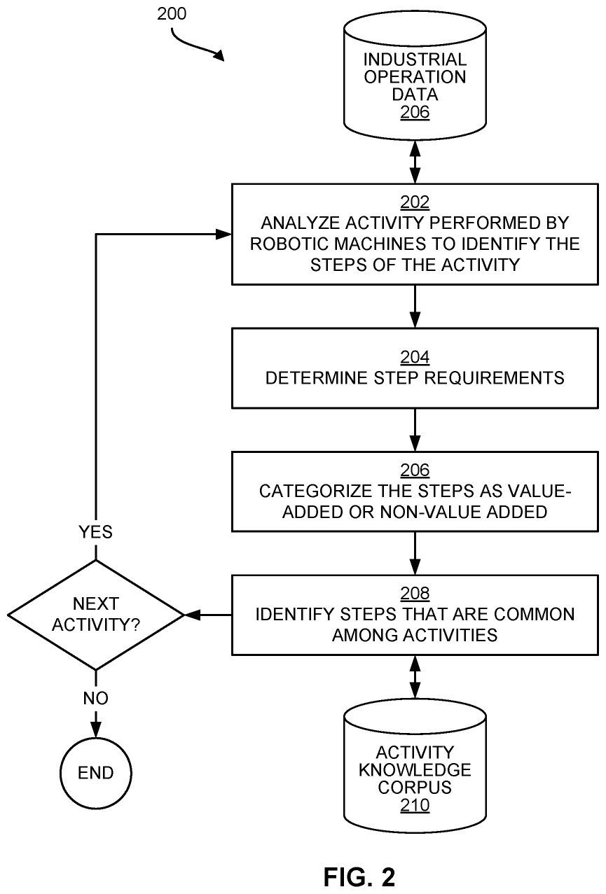

FIG. 2 is a flow diagram that illustrates an example method 200 for building an activity knowledge corpus 210 for one or more machine learning models (e.g., 114 in FIG. 1) to include information for industrial activities performed by an industrial automation system, in accordance with some embodiments of the present disclosure. In some embodiments, the method 200 can be performed by the activity optimization service 104 described in association with FIG. 1.

Starting with operation 202, the method 200 analyzes each activity performed by robotic machines in the industrial automation system to identify individual steps performed by the robotic machines to accomplish the activity. For example, industrial operation data, which can include: industrial activity data, robotic machine data, industrial floor layout information, as well as other information for the industrial automation system is obtained, and the industrial operation data is analyzed to identify one or more activities performed by the robotic machines. After identifying an activity, the method 200 analyzes actions performed by the robotic machines to identify, or define, individual steps that are performed by the robotic machines. In some embodiments, the steps of an activity are labeled for use by one or more machine learning models configured to generate a production plan for an industrial floor.

In operation 204, the method 200 determines the requirements for performing the steps of the industrial activities. Requirements for performing a step can include one or more of: a part requirement, a tool requirement, a position requirement, a temperature requirement, a timing requirement, and the like. As a non-limiting example, requirements for a step that welds a first component to a second component can include: a welder (e.g., a robotic machine welder), coordinates for positioning the components to allow the components to be welded together, an ambient temperature that is most conducive for welding the components, a weld time (a time during which a welding current is applied to the components), as well as other requirements.

In operation 206, the method 200 categorizes the steps of the industrial activities as value-added and nonvalue-added steps. As described earlier, value-added steps of an industrial activity may be steps that directly contribute to the creation, assembly, forming, and/or transforming of a product or process. Inversely, nonvalue-added steps of the industrial activity may be steps that do not directly contribute to the creation, assembly, forming, and/or transforming of the product or process, such as steps that transport, position, transfer, clean, etc. In some embodiments, the method 200 can identify a sequence of steps that reduces the performance of nonvalue-added steps. The sequence of steps can then be selected for performance aggregation.

In operation 208, the method 200 identifies steps that are common among the industrial activities. Steps that are common among two or more industrial activities have the same, or substantially the same, performance requirements. As one example, steps that clean (e.g., sanitize) a product prior to packaging may be common among two or more industrial activities. As another example, steps that transport a product from a production area to a shipping area of an industrial floor may be common among two or more industrial activities. In some examples, the method 200 can determine a degree of commonality (e.g., a percentage, label, etc.) between steps of industrial activities. The method 200 can compare performance requirements of the steps and determine a degree of commonality based on the comparison. Steps identified as having a high degree of commonality can be selected for performance aggregation.

The method 200 can be repeated for each industrial activity performed by the industrial automation system. For each of the industrial activities analyzed by the method 200, the resulting information (e.g., step categorizations, step requirements, and step commonalities) can be stored to the activity knowledge corpus 210, such that the information in the activity knowledge corpus 210 can be used to generate a production plan for the industrial automation system.

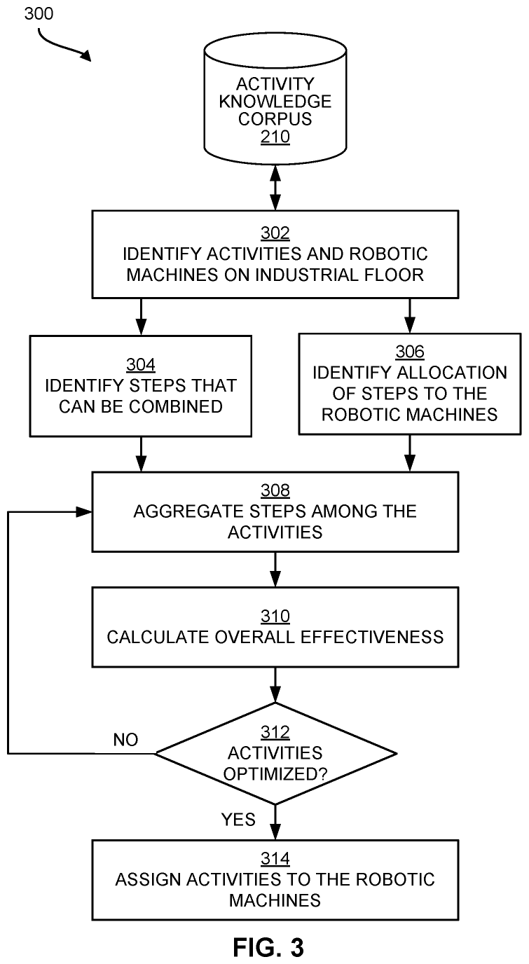

FIG. 3 is a flow diagram illustrating an example method 300 for creating a production plan that optimizes one or more industrial activities, in accordance with some embodiments of the present disclosure. In some embodiments, the method 300 can be performed by the activity optimization service 104 described in association with FIG. 1.

Starting with operation 302, the method 300 obtains information from the activity knowledge corpus 210 described above in association with FIG. 2. The method 300 analyzes the information to identify industrial activities performed on an industrial floor, and the robotic machines located on the industrial floor. In operations 304 and 306, the method 300 further analyzes the information obtained from the activity knowledge corpus 210 to identify steps that can be aggregated or combined and allocated to the robotic machines, including steps that have been identified as having a high degree of commonality, as described above in association with FIG. 2. Based on this analysis, the method 300 in operation 308 selects steps to be aggregated. For example, the method 300 can analyze the steps in view of configuration information for the robotic machines, as well as other configuration information associated with the industrial floor, to determine whether the abilities, physical placement of the robotic machines, dimensions of the industrial floor, etc. allows the steps to be aggregated or combined.

Having identified steps that can be aggregated, the method 300 in operation 310, then calculates an overall effectiveness of aggregating the steps to improve performance of the one or more industrial activities. Improved performance can include, but is not limited to, a decrease in production time, a decrease in processing time, a reduction in resources used to perform the one or more industrial activities, as well as other improvements to aspects of the one or more industrial activities. In some embodiments, calculating the overall effectiveness of aggregating the steps can be determined by executing a simulation of a production plan that assigns the aggregated steps to selected robotic machines, and comparing the results to a current production plan and/or other proposed production plans.

In the case that aggregating the steps does not improve performance of the one or more industrial activities, then the method 300 in operation 312 can repeat operations 308 and 310 to try another aggregation scenario that does improve performance of the one or more industrial activities. In the case that the calculated effectiveness of the aggregation is acceptable (e.g., determined to be optimized), then in operation 314, the method 300 creates a production plan that assigns the steps of the industrial activities to selected robotic machines.

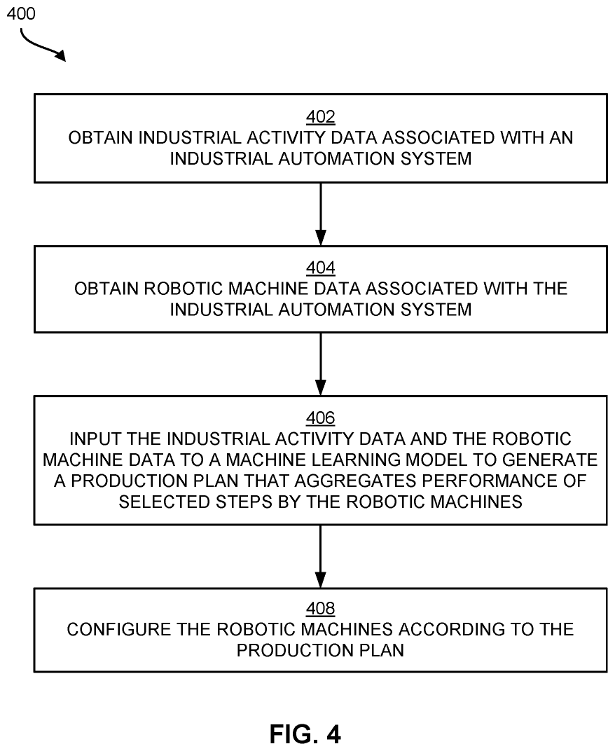

FIG. 4 is a flow diagram that illustrates an example method 400 for configuring robotic machines located on an industrial floor according to a production plan generated by a machine learning model, in accordance with some embodiments of the present disclosure. Starting in operation 402, industrial activity data associated with an industrial automation system is obtained. The industrial activity data can contain historical and/or current information for one or more industrial activities performed by robotic machines included in an industrial automation system. Analysis of the industrial activity data can provide details about steps of an industrial activity that are performed by the robotic machines, such as, for example, steps of an assembly operation that produces an end product, or steps of a process that cleans/sanitizes a commercial food processing floor.

In operation 404, robotic machine data associated with the industrial automation system is obtained. The robotic machine data comprises configuration information of the robotic machines associated with performing the steps of the industrial activities. For example, the robotic machine data can include hardware specifications, software specifications, physical location information, and other information associated with the robotic machines. Analysis of the robotic machine data can provide details about a robotic machine's ability to perform a step of an industrial activity, such as, for example, assembling components of a product, transporting components of a product, cleaning a commercial food processing floor, etc.

In operation 406, the industrial activity data and the robotic machine data are input to a machine learning model that analyzes the steps of the industrial activities in view of the configuration information of the robotic machines to generate a production plan that aggregates performance of selected steps by the robotic machines. In some embodiments, a training dataset is created from historical tracking data of the robotic machines performing the industrial activities, and the machine learning model is then trained to evaluate the steps of the industrial activities in view of the configuration information for the robotic machines to generate a production plan.

In some embodiments, as part of analyzing the steps of the industrial activities to create a production plan, a degree of commonality between the steps of the industrial activities is determined, and steps having a high degree of commonality are selected for performance aggregation. In some embodiments, analyzing the steps of the industrial activities to create a production plan can include identifying a sequence of steps of the industrial activities that reduces the performance of the nonvalue-added steps by the robotic machines. Other considerations that can be evaluated in determining performance aggregation of steps for a production plan include: industrial activity volume, step volume, and patterns in the steps of the industrial activities. Industrial activity volume refers to a quantity of an activity performed (e.g., assembly volume, machining volume, etc.). In cases where an industrial activity volume is significant (e.g., greater than 5% of total industrial activity volume), there may be more opportunities to aggregate the steps of the industrial activity. Similarly, a significant volume or quantity of steps involved in performing an industrial activity, or a significant volume of similar steps among different industrial activities, can indicate opportunities to aggregate steps of the one or more activities. Patterns identified in the steps of one or more industrial activities can also indicate opportunities to aggregate step performance. For example, a sequence of steps performed the same way, or nearly the same way, among industrial activities can indicate an opportunity to aggregate the sequence of steps among the industrial activities.

In operation 408, the robotic machines on the industrial floor are configured according to the production plan generated by the machine learning model. In some embodiments, prior to implementing the production plan, a simulation of the robotic machines performing the industrial activities according to the production plan can be executed to determine the effectiveness of the production plan. If the simulation indicates that the production plan improves performance of one or more industrial activities, the production plan can be implemented in the industrial automation system.

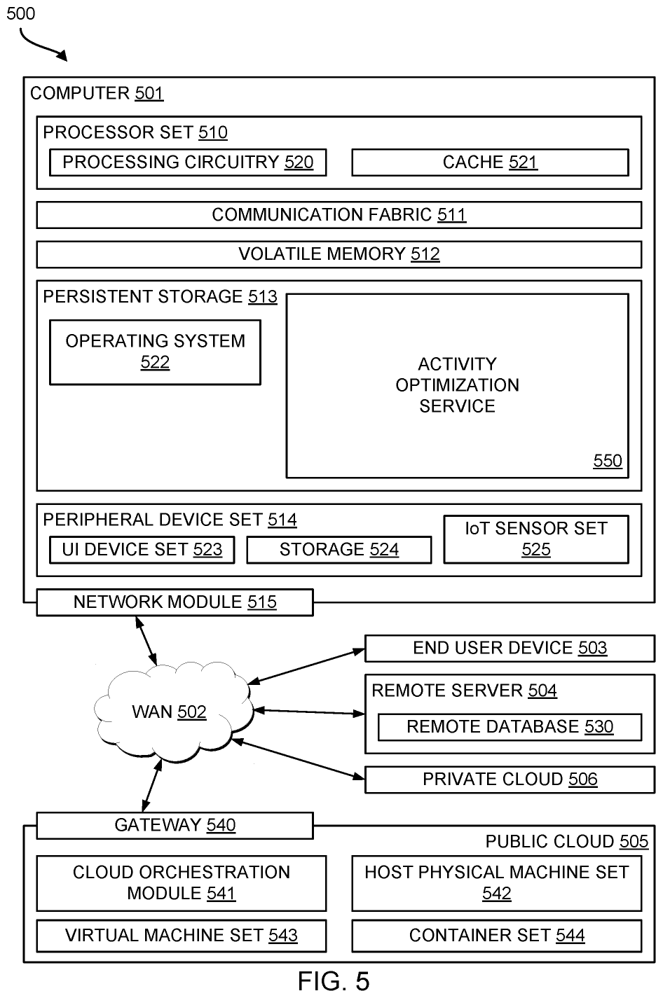

The methods described above in association with FIGS. 2-4 can be performed by a computer (e.g., computer 501 in FIG. 5), performed in a cloud environment (e.g., clouds 506 or 505 in FIG. 5), and/or generally can be implemented in fixed-functionality hardware, configurable logic, logic instructions, etc., or any combination thereof. Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks maybe performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 500 contains an example of an environment for the execution of at least some of the computer code involved in performing the disclosed methods, such as activity optimization service 550. In addition to activity optimization service 550, computing environment 500 includes, for example, computer 501, wide area network (WAN) 502, end user device (EUD) 503, remote server 504, public cloud 505, and private cloud 506. In this embodiment, computer 501 includes processor set 510 (including processing circuitry 520 and cache 521), communication fabric 511, volatile memory 512, persistent storage 513 (including operating system 522 and activity optimization service 550, as identified above), peripheral device set 514 (including user interface (UI), device set 523, storage 524, and Internet of Things (IoT) sensor set 525), and network module 515. Remote server 504 includes remote database 530. Public cloud 505 includes gateway 540, cloud orchestration module 541, host physical machine set 542, virtual machine set 543, and container set 544.

COMPUTER 501 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 530. As is well understood in the art of computer technology, and depending upon the technology, performance of a computer-implemented method may be distributed among multiple computers and/or between multiple locations. On the other hand, in this presentation of computing environment 500, detailed discussion is focused on a single computer, specifically computer 501, to keep the presentation as simple as possible. Computer 501 may be located in a cloud, even though it is not shown in a cloud in FIG. 5. On the other hand, computer 501 is not required to be in a cloud except to any extent as may be affirmatively indicated.

PROCESSOR SET 510 includes one, or more, computer processors of any type now known or to be developed in the future. Processing circuitry 520 may be distributed over multiple packages, for example, multiple, coordinated integrated circuit chips. Processing circuitry 520 may implement multiple processor threads and/or multiple processor cores. Cache 521 is memory that is located in the processor chip package(s) and is typically used for data or code that should be available for rapid access by the threads or cores running on processor set 510. Cache memories are typically organized into multiple levels depending upon relative proximity to the processing circuitry. Alternatively, some, or all, of the cache for the processor set may be located “off chip.” In some computing environments, processor set 510 may be designed for working with qubits and performing quantum computing.

Computer readable program instructions are typically loaded onto computer 501 to cause a series of operational steps to be performed by processor set 510 of computer 501 and thereby effect a computer-implemented method, such that the instructions thus executed will instantiate the methods specified in flowcharts and/or narrative descriptions of computer-implemented methods included in this document (collectively referred to as “the disclosed methods”). These computer readable program instructions are stored in various types of computer readable storage media, such as cache 521 and the other storage media discussed below. The computer readable program instructions, and associated data, are accessed by processor set 510 to control and direct performance of the disclosed methods. In computing environment 500, at least some of the instructions for performing the disclosed methods of activity optimization service 550 are stored in persistent storage 513.

COMMUNICATION FABRIC 511 is the signal conduction paths that allow the various components of computer 501 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 512 is any type of volatile memory now known or to be developed in the future. Examples include dynamic type random access memory (RAM) or static type RAM. Typically, the volatile memory is characterized by random access, but this is not required unless affirmatively indicated. In computer 501, the volatile memory 512 is located in a single package and is internal to computer 501, but, alternatively or additionally, the volatile memory may be distributed over multiple packages and/or located externally with respect to computer 501.

PERSISTENT STORAGE 513 is any form of non-volatile storage for computers that is now known or to be developed in the future. The non-volatility of this storage means that the stored data is maintained regardless of whether power is being supplied to computer 501 and/or directly to persistent storage 513. Persistent storage 513 may be a read only memory (ROM), but typically at least a portion of the persistent storage allows writing of data, deletion of data and re-writing of data. Some familiar forms of persistent storage include magnetic disks and solid-state storage devices. Operating system 522 may take several forms, such as various known proprietary operating systems or open-source Portable Operating System Interface type operating systems that employ a kernel. The code implementing activity optimization service 550 typically includes at least some of the computer code involved in performing the disclosed methods.

PERIPHERAL DEVICE SET 514 includes the set of peripheral devices of computer 501. Data communication connections between the peripheral devices and the other components of computer 501 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 523 may include components such as a display screen, speaker, microphone, wearable devices (such as goggles and smart watches), keyboard, mouse, printer, touchpad, game controllers, and haptic devices. Storage 524 is external storage, such as an external hard drive, or insertable storage, such as an SD card. Storage 524 may be persistent and/or volatile. In some embodiments, storage 524 may take the form of a quantum computing storage device for storing data in the form of qubits. In embodiments where computer 501 is required to have a large amount of storage (for example, where computer 501 locally stores and manages a large database) then this storage may be provided by peripheral storage devices designed for storing very large amounts of data, such as a storage area network (SAN) that is shared by multiple, geographically distributed computers. IoT sensor set 525 is made up of sensors that can be used in Internet of Things applications. For example, one sensor may be a thermometer and another sensor may be a motion detector.

NETWORK MODULE 515 is the collection of computer software, hardware, and firmware that allows computer 501 to communicate with other computers through WAN 502. Network module 515 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 515 are performed on the same physical hardware device. In other embodiments (for example, embodiments that utilize software-defined networking (SDN)), the control functions and the forwarding functions of network module 515 are performed on physically separate devices, such that the control functions manage several different network hardware devices. Computer readable program instructions for performing the disclosed methods can typically be downloaded to computer 501 from an external computer or external storage device through a network adapter card or network interface included in network module 515.

WAN 502 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 503 is any computer system that is used and controlled by an end user (for example, a customer of an enterprise that operates computer 501), and may take any of the forms discussed above in connection with computer 501. EUD 503 typically receives helpful and useful data from the operations of computer 501. For example, in a hypothetical case where computer 501 is designed to provide a recommendation to an end user, this recommendation would typically be communicated from network module 515 of computer 501 through WAN 502 to EUD 503. In this way, EUD 503 can display, or otherwise present, the recommendation to an end user. In some embodiments, EUD 503 may be a client device, such as thin client, heavy client, mainframe computer, desktop computer and so on.

REMOTE SERVER 504 is any computer system that serves at least some data and/or functionality to computer 501. Remote server 504 may be controlled and used by the same entity that operates computer 501. Remote server 504 represents the machine(s) that collect and store helpful and useful data for use by other computers, such as computer 501. For example, in a hypothetical case where computer 501 is designed and programmed to provide a recommendation based on historical data, then this historical data may be provided to computer 501 from remote database 530 of remote server 504.

PUBLIC CLOUD 505 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 505 is performed by the computer hardware and/or software of cloud orchestration module 541. The computing resources provided by public cloud 505 are typically implemented by virtual computing environments that run on various computers making up the computers of host physical machine set 542, which is the universe of physical computers in and/or available to public cloud 505. The virtual computing environments (VCEs) typically take the form of virtual machines from virtual machine set 543 and/or containers from container set 544. It is understood that these VCEs may be stored as images and may be transferred among and between the various physical machine hosts, either as images or after instantiation of the VCE. Cloud orchestration module 541 manages the transfer and storage of images, deploys new instantiations of VCEs and manages active instantiations of VCE deployments. Gateway 540 is the collection of computer software, hardware, and firmware that allows public cloud 505 to communicate through WAN 502.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 506 is similar to public cloud 505, except that the computing resources are only available for use by a single enterprise. While private cloud 506 is depicted as being in communication with WAN 502, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 505 and private cloud 506 are both part of a larger hybrid cloud.

The terminology used herein is for the purpose of describing particular embodiments only and is not intended to be limiting of the various embodiments. As used herein, the singular forms “a,” “an,” and “the” are intended to include the plural forms as well, unless the context clearly indicates otherwise. It will be further understood that the terms “includes” and/or “including,” when used in this specification, specify the presence of the stated features, integers, steps, operations, elements, and/or components, but do not preclude the presence or addition of one or more other features, integers, steps, operations, elements, components, and/or groups thereof. In the previous detailed description of example embodiments of the various embodiments, reference was made to the accompanying drawings (where like numbers represent like elements), which form a part hereof, and in which is shown by way of illustration specific example embodiments in which the various embodiments can be practiced. These embodiments were described in sufficient detail to enable those skilled in the art to practice the embodiments, but other embodiments can be used and logical, mechanical, electrical, and other changes can be made without departing from the scope of the various embodiments. In the previous description, numerous specific details were set forth to provide a thorough understanding the various embodiments. But the various embodiments can be practiced without these specific details. In other instances, well-known circuits, structures, and techniques have not been shown in detail in order not to obscure embodiments.

Different instances of the word “embodiment” as used within this specification do not necessarily refer to the same embodiment, but they can. Any data and data structures illustrated or described herein are examples only, and in other embodiments, different amounts of data, types of data, fields, numbers and types of fields, field names, numbers and types of rows, records, entries, or organizations of data can be used. In addition, any data can be combined with logic, so that a separate data structure may not be necessary. The previous detailed description is, therefore, not to be taken in a limiting sense.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Although the present disclosure has been described in terms of specific embodiments, it is anticipated that alterations and modification thereof will become apparent to the skilled in the art. Therefore, it is intended that the following claims be interpreted as covering all such alterations and modifications as fall within the true spirit and scope of the disclosure.

Any advantages discussed in the present disclosure are example advantages, and embodiments of the present disclosure can exist that realize all, some, or none of any of the discussed advantages while remaining within the spirit and scope of the present disclosure.

What is claimed is:

1. A computer-implemented method comprising:
obtaining industrial activity data comprising steps of industrial activities performed by robotic machines on an industrial floor;
obtaining robotic machine data comprising configuration information of the robotic machines associated with performing the steps of the industrial activities;
inputting the industrial activity data and the robotic machine data to a machine learning model to analyze the steps of the industrial activities in view of the configuration information of the robotic machines to generate a production plan that aggregates performance of selected steps by the robotic machines; and
configuring the robotic machines on the industrial floor according to the production plan generated by the machine learning model.

2. The computer-implemented method of claim 1, further comprising:
creating a training dataset from historical tracking data of the robotic machines performing the industrial activities; and
training the machine learning model to evaluate the steps of the industrial activities in view of the configuration information of the robotic machines to generate the production plan.

3. The computer-implemented method of claim 1, further comprising executing a simulation of the robotic machines performing the industrial activities according to the production plan to determine an effectiveness of the production plan.

4. The computer-implemented method of claim 1, further comprising:
determining a degree of commonality between the steps of the industrial activities; and
selecting steps having a high degree of commonality for performance aggregation.

5. The computer-implemented method of claim 1, further comprising:
identifying a sequence of steps of the industrial activities that reduces the performance of the nonvalue-added steps by the robotic machines; and
selecting the sequence of steps for performance aggregation.

6. The computer-implemented method of claim 1, further comprising identifying industrial activity volume and step volume.

7. The computer-implemented method of claim 1, further comprising identifying patterns in the steps of the industrial activities.

8. A system comprising:
one or more computer readable storage media storing program instructions and one or more processors which, in response to executing the program instructions, are configured to:
obtain industrial activity data comprising steps of industrial activities performed by robotic machines on an industrial floor;
obtain robotic machine data comprising configuration information of the robotic machines associated with performing the steps of the industrial activities;
input the industrial activity data and the robotic machine data to a machine learning model to analyze the steps of the industrial activities in view of the configuration information of the robotic machines to generate a production plan that aggregates performance of selected steps by the robotic machines; and
configure the robotic machines on the industrial floor according to the production plan generated by the machine learning model.

9. The system of claim 8, wherein the program instructions are further configured to cause the one or more processors to:
perform physical distance collaboration analysis for the robotic machines to identify sets of robotic machines that are available to collaborate on one or more steps of one or more industrial activities.

10. The system of claim 8, wherein the program instructions are further configured to cause the one or more processors to:
execute a simulation of the robotic machines performing the industrial activities according to the production plan to determine an effectiveness of the production plan.

11. The system of claim 8 wherein the program instructions are further configured to cause the one or more processors to:
determine a degree of commonality between the steps of the industrial activities; and
select steps having a high degree of commonality for performance aggregation.

12. The system of claim 8, wherein the program instructions are further configured to cause the one or more processors to:
identify a sequence of steps of the industrial activities that reduces the performance of the nonvalue-added steps by the robotic machines; and
select the sequence of steps for performance aggregation.

13. The system of claim 8, wherein the program instructions are further configured to cause the one or more processors to:
identify industrial activity volume and step volume.

14. The system of claim 8, wherein the program instructions are further configured to cause the one or more processors to:
identify patterns in the steps of the industrial activities.

15. A computer program product comprising:
one or more computer readable storage media, and program instructions collectively stored on the one or more computer readable storage media, the program instructions configured to cause one or more processors to:
obtain industrial activity data comprising steps of industrial activities performed by robotic machines on an industrial floor;
obtain robotic machine data comprising configuration information of the robotic machines associated with performing the steps of the industrial activities;
input the industrial activity data and the robotic machine data to a machine learning model to analyze the steps of the industrial activities in view of the configuration information of the robotic machines to generate a production plan that aggregates performance of selected steps by the robotic machines; and
configure the robotic machines on the industrial floor according to the production plan generated by the machine learning model.

16. The computer program product of claim 15, wherein the program instructions are further configured to cause the one or more processors to:
execute a simulation of the robotic machines performing the industrial activities according to the production plan to determine an effectiveness of the production plan.

17. The computer program product of claim 15, wherein the program instructions are further configured to cause the one or more processors to:
determine a degree of commonality between the steps of the industrial activities; and
select steps having a high degree of commonality for performance aggregation.

18. The computer program product of claim 15, wherein the program instructions are further configured to cause the one or more processors to:
identify a sequence of steps of the industrial activities that reduces the performance of the nonvalue-added steps by the robotic machines; and
select the sequence of steps for performance aggregation.

19. The computer program product of claim 15, wherein the program instructions are further configured to cause the one or more processors to:
identify industrial activity volume and step volume.

20. The computer program product of claim 15, wherein the program instructions are further configured to cause the one or more processors to:
identify patterns in the steps of the industrial activities.
